(19) United States
(12) Patent Application Publication
(10) Pub. No.: US 2013/0060614 A1
(43) Pub. Date: Mar. 7, 2013

(54) Local network for beauty salons

(71) Applicants: Irina Anikina, Atherton, CA (US); Sergey Anikin, Atherton, CA (US)

(72) Inventors: Irina Anikina, Atherton, CA (US); Sergey Anikin, Atherton, CA (US)

(21) Appl. No.: 13/199,636

(22) Filed: Sep. 6, 2011

(51) Int. Cl. G06Q 50/10; G06Q 30/00

(52) U.S. Cl. 705/14.4

(57) ABSTRACT

The invention provides a self-contained local network for a group of specialized beauty salons located in a certain area. The main distinction of the proposed beauty-salon service network is that it allows subscribed customers to obtain products, advertisements, consultations, and other services that cannot be obtained at all or for competitive costs from stores, shops, or salons beyond the network. The network includes a common, powerful computer or server that is connected through a web site of a master salon with individual web sites of other salons of the system, a plurality of services that include consultation services from remotely located top stylists, cosmetologists, etc. The network also provides access to an Internet shop, delivery service, scheduling service, etc.

### FIELD OF THE INVENTION

The present invention relates to the field of customer service and, in particular, to beauty salons, specifically to a local network for servicing beauty salons located in a certain area.

### BACKGROUND OF THE INVENTION

An average hair appointment in a beauty salon lasts for about 45 minutes for a haircut and from one to two hours for color, 45 minutes of which includes processing and shampooing.

A younger clientele, from age 18 to 25, goes to a salon once every six to eight weeks for highlights and haircuts. Clientele from age 30 to 70 goes to a salon approximately every three weeks for a regular color touchup to cover gray, plus a haircut or blow-dry.

After a client checks in for an appointment, there is usually a waiting period from five to ten minutes before the client is seated at a station.

During a hair appointment, the following usually happens: the first 10 to 15 minutes there is communication between the stylist and client, such as a consultation, basic conversation, etc. The rest of the time the client usually pages through a stack of magazines or newspapers, makes phone calls, or just sits and waits. During a manicure appointment, which is usually 30 minutes, a client has only five minutes to look through a magazine before a nail technician begins work on the client's hands. The client can converse with the nail technician or simply look around.

According to the rating of the salon or spa and prices for services, time for additional service is typically 30 minutes to one hour for a manicure; 30 minutes to one hour for a pedicure; and 30 minutes to one hour for makeup application. In other words, if a client visits a beauty salon for several sequential treatments, e.g., hair coloring, makeup, manicure, and pedicure, this client may spend several hours in the salon.

Thus, a client who visits a beauty salon can spend a long period of unproductive time while waiting until a treatment is completed.

Attempts have been made heretofore to provide computer-assisted beauty-salon services. For example, US Patent Application Publication No. 20030065524 published on Apr. 3, 2003 (inventors: Daniela Giacchetti, et al) discloses a virtual beauty consultant and a method for providing customers with electronic beauty analyses. Beauty information may be maintained in a data structure. A customer may initiate an analysis through an interface coupled with a data structure. A virtual consultant may visually and/or audibly present queries to the customer through the interface. Responses to queries can be retrieved, and information reflective of these responses can be incorporated into subsequent queries. The user-access systems can be coupled with a collaborative network of central processors or servers. A network may include a public network such as the Internet, a private network, a virtual private network, or any other mechanism for enabling communication between two or more nodes or locations. The network may include one or more wired or wireless connections. The user-access system and server system may be, in an exemplary embodiment, operatively connected to the network by communication devices and software known in the art, such as are commonly employed by Internet service providers or as part of an Internet gateway. Beauty information may be stored in a data structure. In one embodiment, a data structure can be contained in computer memory, such as RAM, ROM, magnetic and optical storage media, audio disks, video disks, organic storage media, and any other information storage mechanisms.

US Patent Application Publication No. 20100005489 (Inventor: Mark A. Losey) discloses a media delivery kiosk that can be deployed at an establishment to deliver targeted advertisements to people waiting in the establishment, such as a restaurant, beauty parlor, doctor's office, etc. Through the analysis of demographic information, advertisements likely to appeal to people waiting at a particular establishment can be delivered. The kiosk may also be interactive, which can aid in the gathering of additional demographic information about a specific user or the establishment. Advertising selection can be further user-tuned based on this demographic information, and selected ads can be dynamically delivered in real-time.

A disadvantage of the known computerized beauty salon service systems is that they provide customers with common access to conventional networks that advertise and sell products and services that are attainable by anybody through the Internet from any location, irrespective of whether it is from home or from a beauty salon. In other words, known computerized beauty salons are conventional beauty salons with access to the conventional Internet and thus to conventional Internet services.

### SUMMARY OF THE INVENTION

According to the present invention, the local network for beauty salons comprises a self-contained network that covers a plurality of specialized beauty salons located in a certain area and served by the aforementioned local network. The main distinction of the proposed beauty-salon service network is that it provides customers with services offered only by a particular line of beauty salons that is included in the network. In other words, the network allows customers to obtain products, advertisements, consultations, and other services at competitive costs that are not available from stores, shops, or salons beyond that network.

The plurality of salons covered by the network includes at least one master salon that constantly supports, maintains, and updates the aforementioned beauty salon network through its own Internet site. All beauty salons within the network have their own passwords for access to the network site. The network may provide salon customers with a number of services such as, e.g., an Internet shop that sells specialized beauty products that are marked with the network brand; design services for selection of hair shapes and styles; real-time cosmetology consultations; service schedule reminders; information about products and promotions for valued customers; etc. The network offers delivery of the purchased products and also includes a physical store that, if necessary, may be connected to the shops that are outside the network.

The site may also provide optional services such as watching films, news, advertisements in a selected language, etc, to the client who waits for services. A portion of the services can be provided in the interactive mode. For example, a customer's head is photographed by means of a camera or cameras, the obtained pictures are sent to the design services through the Internet site, and based on the sent data, licensed consultants who are located outside the beauty salon can provide feedback with hair styles and shapes most suitable for the customer in the form of a photograph showing the applied hair style.

The hair stylist mirror may incorporate a video camera, since it is better to see the results of the stylist's work by viewing a short video clip that illustrates the customer's hairstyle before and after treatment. In this case, the customer may turn his/her head to see the hair cut/style from the front, side, and back.

Access to the above-described information and services can be made through telecommunication equipment built into a hairdresser's chair. This equipment may include a computer pad, such as an iPad (manufactured by Apple). The pad may be built into the chair used for hairstyling or attached to the chair through a manipulating pantograph. Alternatively, the pad can stand alone or can be attached to the mirror. The head-photographing camera also can be attached to the back of the chair and stored in the inoperative position so as not to interfere with the hairdresser operation or moved through a multilinked mechanism to a position required for phototaking. According to another aspect of the invention, a computer monitor or a computer pad can be built into or attached to the working mirror in front of the chair.

At no charge the beauty salon will provide connection to the network site, TV, Wi-Fi router, Internet router, etc. Besides, the salon will provide a free merchant account to accept credit cards within the network. This is a new feature that is not yet employed by many beauty salons known to the applicant. With this new feature, customers can pay for salon service and products shown on the computer pad screen or computer monitor at the beauty salon by using the salon system credit card.

The aforementioned network-accessible computer pads will be installed only in the beauty salons for which a state license is required. (To open a beauty salon, the owner must comply with all regulations of the respective State Board of Barbering and Cosmetology. Also, to obtain a cosmetology license, an individual must attend a special school and pass the State exam [for example, California State Board of Cosmetology License Requirements—1600 hours of study]. This means that only highly qualified professionals are able to provide customers with the above-mentioned information and services.)

Another advantage of the network is that some of the vendors will prefer to distribute their products only through licensed professionals. These professionals require considerably large quantities and varieties of products while going about their daily business. Buying and consuming in bulk proves to be economical. In the majority of cases, salon specialists included in the proposed network will offer completely organic, 100% natural products that are highly recommended for health, hygiene, and environmental reasons. These products are free of chemicals, have therapeutic values, are not tested on animals, and can be purchased at an affordable cost.

### BRIEF DESCRIPTION OF THE DRAWINGS

FIG. 1 is a block-diagram of the self-contained network of the invention that incorporates specialized beauty salons.

FIG. 2 is three-dimensional view of a special hairstyling chair for use in beauty salons covered by the network of the invention.

### DETAILED DESCRIPTION OF THE INVENTION

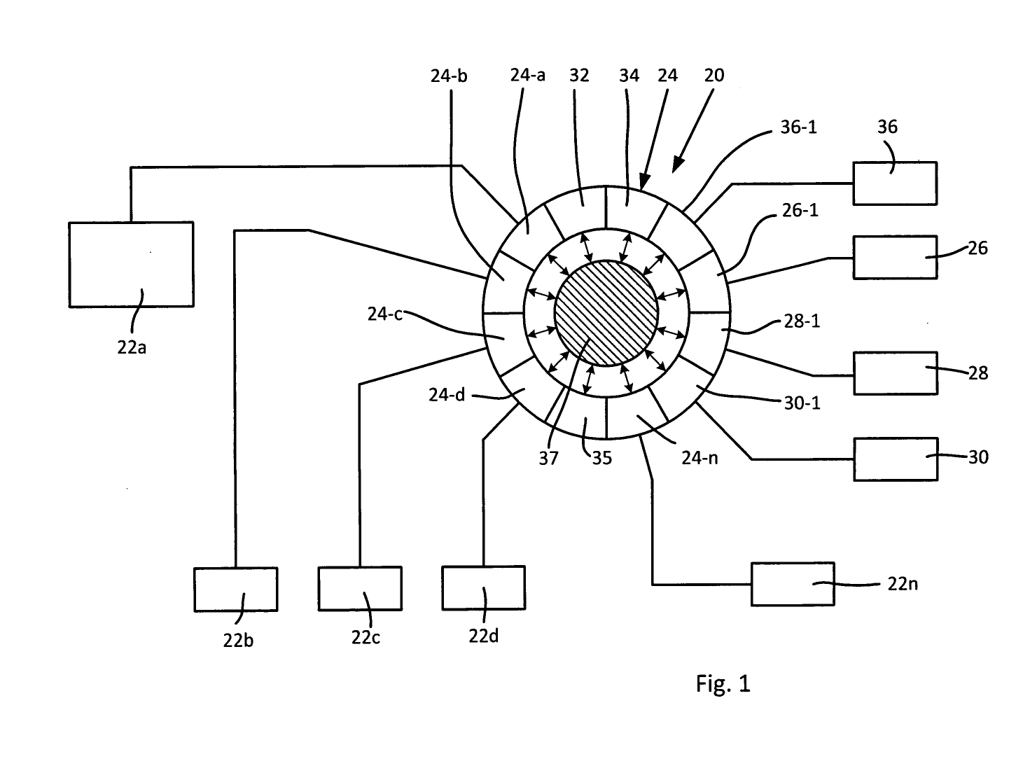

According to the invention, the local network for beauty salons comprises a self-contained network 20 (shown in FIG. 1) that covers a plurality of specialized beauty salons 22a, 22b, 22c . . . 22n located in a certain area and served by the aforementioned network. Generally speaking, professional local networks are well known. However, their application for the beauty salon system according to the present invention is associated with some specifics and therefore requires essential modifications. More specifically, implementation of the local beauty salon system network served by the network 20 involves participation not only of the conventional licensed stylists working in the salon but also of top-level stylists, designers, cosmetologists, etc., located remotely, even in other states or countries. Such top specialists consider the products of their work, such as consultations, suggestions, evaluations, style modifications, etc., to be extraordinary and expensive products that in the majority of cases constitute personal intellectual property that requires legal protection. This condition dictates that the network 20 be a closed or self-contained network, with access only for participants within the network and customers of the beauty salon system for which the network 20 is designed.

Thus, the main distinction of the proposed beauty-salon service network 20 is its provision of services unattainable from locations other than a beauty salon that is included within the network or from other locations provided that permission is received from the salon system by subscription and through the use of individual codes. The network 20 provides the subscribed customers with the advantages of obtaining products, advertisements, consultations, and other services at competitive costs from stores, shops, or salons beyond the network or products that cannot be obtained at all. Such advantages also includes time savings provided through the use of said services, discounts for services and products acquired within the local network, and the possibility of obtaining discounted natural products.

In other words, the plurality of the salons 22a, 22b, 22c . . . 22n covered by the network 20 includes at least one master salon, e.g., the salon 22a, that constantly supports, maintains, and updates the aforementioned beauty salon network 20 (hereinafter referred to as a local network) through its own Internet Media common web site, hereinafter referred to as Master Web Site, which in FIG. 1 is designated by reference numeral 24 and which incorporates individual salon web site, hereinafter referred as individual web site 24a, 24b, 24c, . . . 24n of the specialized beauty salons 22a, 22b, 22c . . . 22n. All individual salon web sites have the same style of design and may have a common trademark that belongs to the salon group served by the network system. The Master Web Site 24 is controlled from the master salon 22a. Links between the individual web site salons 22a, 22b, 22c . . . 22n are carried out through the Master Web Site 24.

All individual beauty salons 22a, 22b, 22c . . . 22n of the network 20 have their own passwords to access the Master Web Site 24. Access to the Master Web Site 24 is available for the subscribed customers of the local network and only from the salon terminals or from other locations but with salon permission. The network 20 may provide salon customers with a number of services such as, e.g., an Internet shop 26 that has its own web site 26-1 included in the Master Web Site 24 and sells specialized beauty products that are marked with the network brand; design services 28 with its own web site 28-1 within the Master Web Site 24 for selection of hair shapes and styles (this service may be supported by outside top designers or stylists, also in the interactive manner); real-time cosmetology consulting service 30 from highly skilled stylists and clinics, also through its own web site 30-1 included into the Master Web Site 24; a scheduled interservice reminder 32 included in the Master Web Site 24; a common information data base 34 about products and promotions for valued customers; etc. The network 20 offers delivery of purchased products through a delivery service 36 having its own web site 36-1 and controlled from the Master Web Site 24. The network Internet shop 26 includes a physical store that, if necessary, may be connected to the shops that are outside the network system (not shown). Reference numeral 37 designates a virtual common data base accessible by any registered client. Reference numeral 35 designates a common network advertiser.

Thus, it has been shown that the above services are available only for subscribed customers of beauty salons served by the local network of the invention and comprise, e.g., hair-design service, cosmetology service, nail-design service, an Internet shop, and a delivery service, each service of said plurality of salons having its own web site that communicates with the master web site and, hence, with each salon of said plurality through its individual web site.

In reality, the physical structure of a beauty salon that is served by the network 20 includes, apart from conventional beauty salon equipment, some specialized items that are described below.

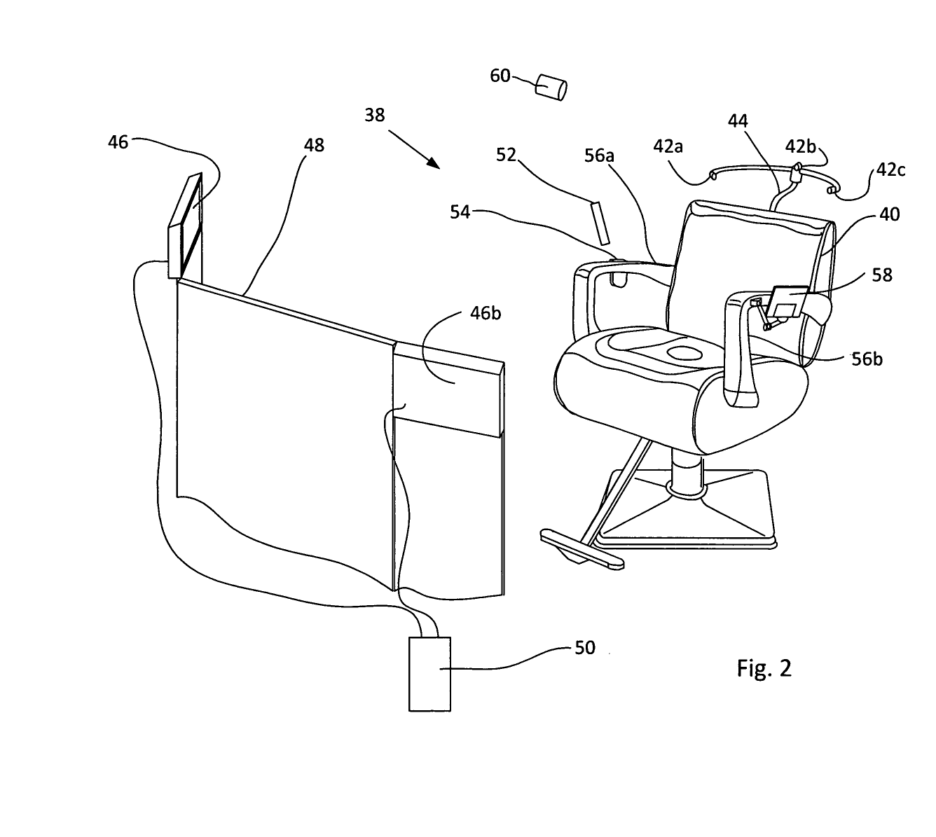

One of these items is a special chair 38 for hairstyling (shown in FIG. 2). The chair back 40 is equipped with an overhead head-photographing camera 42 that is attached to means for positioning at desired points around a customer's head, the means being an articulation mechanism 44, which in turn is attached, e.g., to the upper side of the chair back 40. With use of the aforementioned articulation mechanism 44, the camera 42 can be installed and fixed practically in any position around the head of the customer sitting in the chair 38. The electronics (not shown) that supports operation of the cameras is provided with a data acquisition unit that stores the files produced by the camera 42.

Alternatively, the space around the chair can be provided with three individual head-photographing cameras 42a, 42b, and 42c, and the computer or a server 50 can be provided with means for converting 2D images made by the cameras 42a, 42b, and 42c into 3D images that may be required for services by the top stylist. Such image conversion means was developed by Samsung Electronics Co., Ltd. and is described in US Patent Application Publication 20110126160 published on May 26, 2011 (Inventor: Ji-Youn Han, et al). This publication discloses the method of providing a three-dimensional (3D) image and a 3D display apparatus. If a predetermined instruction is entered into 2D mode, the display mode changes to 3D mode. A predetermined format is applied to an incoming image, and the resultant image is displayed in 3D mode. If the predetermined instruction is entered again in 3D mode, another format is applied to the incoming image and the resultant image is displayed. As a result, a viewer can conveniently select a 3D-image format for the incoming image.

With the use of the articulation mechanism 44, the camera 42 (the mechanism is shown only for one camera, i.e., 42) can be moved to a position that does not disturb the customer or stylist. The scan is made prior to the hairstyling treatment in order to obtain style recommendations or after the treatment for observation by the customer. The stored files make it possible to create a static as well as a dynamic three-dimensional image of the customer's head by the means described above.

The scanned data can be transmitted through the Master Web Site 24 to the design service 28 for evaluation by a highly skilled stylist located at the design services 28 in real time or beyond the services in a shared time schedule. Such an interactive evaluation in real time means that after transmission of the scanned data to the design services, the consultant elaborates recommendations or proposals that can be presented, e.g., with reference to the hair style catalogs developed by and belonging only to the consultant. Such a system makes it possible to obtain hairstyle recommendations from famous or well recognized top stylists. Furthermore, the network 20 restricts individuals who are not salon system customers from access to network services, including the aforementioned specialized design service 28.

Results of evaluations and proposals of the design-service specialist can be presented in a desired format on video display 46a. If necessary, a second video display can be provided so that one display stands alone and another is built into the mirror 48 installed in front of the chair 38. The video display 46 is linked with a powerful computer or a server 50 that belongs to the entire local network 20 and maintains a link with each individual salon of the network. In other words, the display 46 may show all input and output of the subscribed customer to and from the local network 20.

It is understood that due to connection to the service, the display 46 may be used for displaying, e.g., films, advertisements, pages of magazines, or products belonging to the Internet Shop 26. Alternatively, the customer may obtain information from the conventional Internet.

Reference numeral 52 designates a remote control console that can be held in a customer's hand or that is located in an easily accessible location, e.g., in a recess 54 of one of the chair arms 56a and 56b. The chair arm 56b may support an iPad 58 that can be connected to the network 20 through the Wi-Fi and that accomplishes the same functions as the remote control 52 with the screen 46. Such a connection can be used at no charge not only through Wi-Fi but also through a TV router, Internet router, etc. Besides, the salon will provide a free merchant account to accept credit cards for salons within the network. The customers can pay for salon services and products shown on the computer pad screen or computer monitor at the beauty salon.

The hairstylist workstation may incorporate a video camera 60 (or cameras), since it may be desirable to see the results of the stylist's work by viewing a short video clip that illustrates the customer's hairstyle before and after treatment. In this case, the customer may turn his/her head to view the haircut or style from the front, side, and back.

Other special services included into the salon network 20 is the aforementioned real-time cosmetology consulting service 30 which can be realized through the use, e.g., of a system for analyzing skin conditions of customers using digital images of the type described, e.g., in U.S. Pat. No. 7,477,767 issued in 2009 to R. Chhibber, et al. The system comprises units for acquiring a white-light image and an ultraviolet image of at least a portion of the customer's face or other part of the body. Each of the white-light and UV images includes a plurality of pixels, and each pixel in the UV image corresponds to a respective pixel in the white-light image. The system identifies skin-pixels in the white-light and UV images and obtains results associated with at least one skin condition using information in the skin pixels in the first white light and UV images. The imaging equipment of the system for analyzing skin conditions can operate not only in UV light but also in other wavelength ranges, including visible light, infrared light, etc. In monochromatic light, some features of the skin, such as sclerotic lesions, are more easily revealed than in white light. For this, reason, provision of such a universal system in the beauty salon of the system of the present invention will significantly facilitate precosmetic detection of skin defects. It is understood that use of such precosmetic detection system and prescription of treatment procedures involve participation of a skilled dermatologist who may be distantly located and who may serve several salons within the system. It is understood that data exchange is carried out in an interactive mode and in accordance with the scheme described above for consultation with remotely located stylists.

The aforementioned network-access iPads 58 may be installed only in beauty salons for which a state license is required. (To open a beauty salon, the owner must comply with all regulations of the respective State Board of Barbering and Cosmetology.) Also, to obtain a cosmetology license, an individual must attend a special school and pass the State exam (for example, California State Board of Cosmetology License Requirements—1600 hours of study). This means that only highly qualified professionals are able to provide customers with the above-mentioned information and services.

Another advantage of the network is that some of the vendors will prefer to distribute their products only through licensed professionals. These professionals require considerably large quantities and varieties of products while going about their daily business. Buying and consuming in bulk proves to be economical. In the majority of cases, salon specialists included in the proposed network will offer completely organic, 100% natural products, which are highly recommended for health, hygiene and environmental reasons. These products are free of chemicals, have therapeutic values, are not tested on animals, and can be purchased at an affordable cost.

In order to shorten the time of costly consulting services by outside consultants, the salon network may incorporate an optimized schedule for sending consultation requests to the remotely located stylists, dermatologists, etc., and for receiving responses in a shared-time mode, if a rear-time service is unattainable.

Although the salon network service is described above with regard to haircuts and hair styling, the network services equally applies to other treatments, such as manicures, pedicures, facial treatments, color treatments, tattoos, etc.

An example of operation of the salon network will be considered below with reference to a female customer, although the same principle applies to male customers as well. Furthermore, the salon network of the invention provides a great variety of services. Therefore, it should be understood that the service described below exclusively for hair styling is considered to be one example in a great variety of examples, e.g., nail design, etc. Also, the example relates to a customer who visits a master salon. However, through links to the network 20, the same services can be obtained from any salon included in the network 20.

Roughly, all customers are divided into two groups, i.e., first-time customers, who received information about the salon services from friends or an advertisement, and permanent, registered customers. When a first-time customer visits one of the salons, e.g., the salon 22c, which is served by the self-contained network of the invention, and wishes to have a service, e.g., hair styling, she or he first receives a free consultation at which time the stylist determines the best way to meet the customer's need. First, the customer is registered and subscribes for the services. The customer is then offered all services provided within the self-contained network, including service of remotely located top stylists with certain prepayment. If the customer does not need to contact the top stylist in real time, the existing hairstyle of this customer will be photographed with the camera 42, and the set of photographs and files that may reproduce a 3D image of the customer's head will be sent to the top stylist. Results of evaluation and recommendation elaborated by the top stylist will be delivered to the specialized beauty salon. The visit of the customer to the salon is scheduled, and the customer is informed about the time available for treatment.

When the customer arrives at the salon at a scheduled time, she/he occupies the chair 38 and is subjected to treatment. If during treatment the customer has a waiting period that may occur, e.g., during coloring or drying, this time can be used to review the virtual catalogs of the self-contained network 20 included in the virtual common data base 37 and, if necessary, and for ordering selected products from the Internet shop 26 of the network 20. In this case, the customer establishes a convenient delivery time from the delivery service 36. At the same time, the customer may obtain information about other services, such as cosmetology, nail treatment, etc., and may schedule another appointment if consultation is needed.

It is understood that the procedures described above may occur at any salon in the system from 22a to 22n and customers of all salons served by the network 20 may obtain information from the virtual common database 37 of the master web site 24. Through the master salon 22a, the master web site 24 assigns appointments, treatments, consultations, and other services common to the network 20.

It is also understood that a great variety of treatments, services, consultations, advertisements, etc., are possible by using all of the facilities shown in FIG. 1. For example, a customer may visit any salon in the system, e.g., for nail design, pedicure, or purchase of specialized or natural products unavailable from any other locations or services except from the network 20.

For permanent customers, the procedure is the same except that they do not need to register or subscribe and their visits can be scheduled on a routine basis.

The invention is not limited to the specific example of the network 20 shown in the drawings and described in the specification, and any changes and modifications are possible without departure from the scope of the patent claims.

1. A local network for beauty salons comprising:
a computer for controlling all operations provided by the local network;
at least one beauty salon provided with a master web site that comprises at least one individual web site belonging to said at least one beauty salon;
a plurality of services available only for subscribed customers of said at least one beauty salon comprising a hair-design service, a cosmetology service, a nail-design service, an Internet shop, and a delivery service, each service of said plurality having its own web site communicating with said master web site;
a common network advertiser also communicating with the master web site;
a virtual common database for storing information of the entire local network;
said hair-design service, cosmetology service, nail-design service, and Internet shop comprising for subscribed customers special services unattainable from sources other than said at least one beauty salon and characterized by advantages over the services of other than said at least one beauty salon.

2. The local network of claim 1, wherein the hair-design service comprises a top stylist consultation service available on a real-time basis or on a shared-time basis.

3. The local network of claim 1, wherein the cosmetology service comprises a top cosmetologist consultation service available on a real-time basis or on a shared-time basis.

4. The local network of claim 1, wherein said advantages comprise time savings provided through the use of said services, discounts for services and products acquired through the local network, and the possibility of obtaining discounted natural products.

5. The local network of claim 2, wherein said advantages comprise time savings provided through the use of said services, discounts for services and products acquired through the local network, and the possibility of obtaining discounted natural products.

6. The local network of claim 3, wherein said advantages comprise time savings provided through the use of said services, discounts for services and products acquired through the local network, and the possibility of obtaining discounted natural products.

7. The local network of claim 1, wherein each salon comprises a chair for hairstyling, a mirror in front of the chair, at least one head-photographing camera provided with means for positioning at a desired point around the customer's head, at least one video camera remotely located in front of the chair, a video display observable by the customer from the chair and displaying all input and output of the subscribed customer to and from the local network, and a remote control in the arm of the chair for controlling operations of said computer.

8. The local network of claim 7, wherein the video display stands alone or is built into the mirror.

9. The local network of claim 7, wherein the chair is provided with an iPad, which is easily accessible to a customer who occupies the chair and that has access to all services in the local network.

10. The local network of claim 8, wherein said at least one salon has at least three head-photographing cameras for obtaining 2D images and the computer has means for converting 2D images into 3D images that can be sent to the top stylist.

11. The local network of claim 9, wherein said at least one salon has at least three head-photographing cameras for obtaining 2D images, and the computer has means for converting 2D images into 3D images that can be sent to the top stylist.

12. A local network for beauty salons comprising:
a computer for controlling all operations provided by the local network;
a plurality of beauty salons, each having its own individual web site, one salon of said plurality comprising a master salon provided with a master web site accessible from each salon through its respective individual web site;
a plurality of services available only for subscribed customers of said beauty salons and comprising a hair-design service, a cosmetology service, a nail-design service, an Internet shop, and a delivery service, each service of said plurality having its own web site communicating with said master web site and, hence, with each salon of said plurality through its individual web site;
a common network advertiser also communicating with the master web site;
a virtual common database for storing information of the entire local network accessible from the master salon and, hence, from each salon of said plurality through its individual web site, said hair-design service, cosmetology service, nail-design service, and Internet shop comprising for subscribed customers special services unattainable from sources other than said at least one beauty salon and characterized by advantages over services other than said at least one beauty salon.

13. The local network of claim 12, wherein the hair-design service comprises a top stylist consultation service available on a real-time basis or on a shared-time basis.

14. The local network of claim 12, wherein the cosmetology service comprises a top cosmetologist consultation service available on a real-time basis or on a shared-time basis.

15. The local network of claim 12, wherein said advantages comprise time savings provided through the use of said services, discounts for services and products acquired through the local network, and the possibility of obtaining discounted natural products.

16. The local network of claim 12, wherein each salon comprises a chair for hairstyling, a mirror in front of the chair, at least one head-photographing camera provided with means for positioning at a desired point around the customer's head, at least one video camera remotely located in front of the chair, a video display observable by the customer from the chair, a remote control in the arm of the chair for controlling operations of said computer, and at least one display for displaying all input and output of the subscribed customer to and from the local network.

17. The local network of claim 16, wherein the video display stands alone or is built into the mirror.

18. The local network of claim 16, wherein the chair is provided with an iPad, which is easily accessible to a customer who occupies the chair and that has access to all services of the local network.

19. The local network of claim 17, wherein each salon has at least three head-photographing cameras for obtaining 2D images and the computer has means for converting 2D images into 3D images that can be sent to the top stylist.

20. The local network of claim 18, wherein each salon has at least three head-photographing cameras for obtaining 2D images and the computer has means for converting 2D images into 3D images that can be sent to the top stylist.
